(19) United States
(12) Patent Application Publication
(10) Pub. No.: US 2026/0197868 A1
(43) Pub. Date: Jul. 9, 2026

(54) COORDINATED ACCESS POINT ASSISTANCE INDICATION AND POLLING

(71) Applicant: QUALCOMM Incorporated, San Diego, CA (US)

(72) Inventors: Gaurang NAIK, San Diego, CA (US); Abhishek Pramod PATIL, San Diego, CA (US); Sanket Sanjay KALAMKAR, San Diego, CA (US); Sai Yiu Duncan HO, San Diego, CA (US); Giovanni CHISCI, San Diego, CA (US); Sherief HELWA, San Diego, CA (US); George CHERIAN, San Diego, CA (US); Alfred ASTERJADHI, San Diego, CA (US)

(21) Appl. No.: 19/013,346

(22) Filed: Jan. 8, 2025

(51) Int. Cl. H04W 74/0816; H04L 5/00; H04W 74/06

(52) U.S. Cl. CPC H04W 74/0816; H04L 5/0053; H04W 74/06

(57) ABSTRACT

Certain aspects of the present disclosure provides a method for indicating a potential need for assistance. According to certain aspects, an apparatus (e.g., an AP) obtains information indicating a first wireless node is a candidate for participating in a coordinated communication scheme during at least one transmit opportunity (TXOP), wherein the apparatus is associated with a first basic service set (BSS) and the first wireless node is associated with a second BSS and participates in the coordinated communication scheme with the first wireless node during the at least one TXOP.

### TECHNICAL FIELD

This disclosure relates generally to wireless communication, and more specifically, to mechanisms for signaling an indication a wireless node could benefit from participating in a coordinated communication scheme with another wireless node.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a wireless device. The method includes obtaining information indicating a first wireless node is a candidate for participating in a coordinated communication scheme during at least one transmit opportunity (TXOP), wherein the wireless device is associated with a first basic service set (BSS) and the first wireless node is associated with a second BSS and participating in the coordinated communication scheme with the first wireless node during the at least one TXOP.

Another innovative aspect of the subject matter described in this disclosure can be implemented in a method for wireless communication at a wireless device. The method includes providing information indicating the wireless device is a candidate for participating in a coordinated communication scheme with a first wireless node during at least one transmit opportunity (TXOP), wherein the first wireless node is associated with a first basic service set (BSS) and the wireless device is associated with a second BSS and participating in the coordinated communication scheme with the first wireless node during the at least one TXOP. Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIG. 8 shows an example call flow diagram for indicating a potential need for assistance, in accordance with aspects of the present disclosure.

FIG. 9 shows an example format of a feedback type field that can indicate a request for feedback regarding a potential need for assistance or resources, in accordance with aspects of the present disclosure.

FIG. 10 shows an example format of indicating a potential need for assistance using random access (RA) resource units (RUs), in accordance with aspects of the present disclosure.

FIG. 11 shows an example flowchart illustrating example processes performable by or at a wireless node, in accordance with aspects of the present disclosure.

FIG. 12 shows an example flowchart illustrating example processes performable by or at a wireless node, in accordance with aspects of the present disclosure.

FIG. 13 shows a block diagram of an example wireless communication device

Like reference numbers and designations in the various drawings indicate like elements.

### DETAILED DESCRIPTION

Certain mechanisms may be applicable to communications between wireless nodes, such as between access point (AP) and non-AP stations (STAs), between APs, and/or between non-AP STAs.

For example, ultra-high reliability (UHR)/Wi-Fi 8 may introduce certain Coordinated AP (CAP) mechanisms (or schemes) where multiple APs may coordinate to enhance communications in some manner. Such mechanisms, for example, may allow two or more APs to coordinate their resources in various ways. CAP mechanisms may also be referred to as multi-AP coordination (MAP-C or MAPC) mechanisms (or coordinated communicating schemes).

As examples of CAP mechanisms, coordinated time division multiple access (C-TDMA) may be used to coordinate resources in the time domain, coordinated spatial reuse (C-SR) may be used to coordinate resources in the spatial domain, or coordinate listen intervals (CLI) may be used to coordinate access to the wireless medium. In this context, CLI may include coordinated service periods (SPs), such as coordinated target wakeup time (C-TWT), coordinated restricted target wakeup time (C-RTWT), Inter-AP Coordination Intervals/Epochs, Inter-AP Service Intervals/Epochs, and AP coordination Intervals/Epochs. Similarly, coordinated beamforming (C-BF), and/or coordinated preemption (C-Preemption) may be used to coordinate preemption among neighboring (such as friendly) APs. Moreover, two or more APs may be a part of a multi-link device (MLD) (e.g., a single mobility domain (SMD) MLD or similar central entity) and may offer seamless roaming functionality to associated clients (such as non-AP STAs).

In some cases, an AP that shares part of a transmit opportunity (TXOP) it owns (e.g., a Sharing AP) may participate in a CAP scheme with another AP it shares the TXOP with (e.g., a Shared AP). In some cases, it may be assumed that the sharing AP has some knowledge that a shared AP (or shared APs) need assistance (e.g., meaning they could benefit from participating in the CAP scheme), such as if they have a certain amount or type of buffered or anticipated traffic the AP(s) might be able to empty their traffic queues and thereby improve a communication latency, throughput, reliability, or any combination thereof. In some cases, knowledge of need for assistance may be achievable, for example, if the sharing AP and shared AP(s) have tight backhaul coordination (e.g., in enterprise networks where APs are likely deployed by single vendor).

However, in many environments (e.g., residential deployments) such a tight coordination may not be feasible, and the sharing AP may be generally unaware of whether the shared AP(s) need assistance.

Aspects of the present disclosure provide techniques and mechanisms that may allow an AP (e.g., a shared AP) to indicate a need for assistance. Via such mechanisms, a shared AP may indicate that it is a candidate to benefit from participating in a CAP scheme with a sharing AP. As a result, aspects of the present disclosure may allow for better coordination, improve resource utilization, reliability, reduce latency, increase system throughput, and improve overall user experience.

### Example Wireless Communication Network

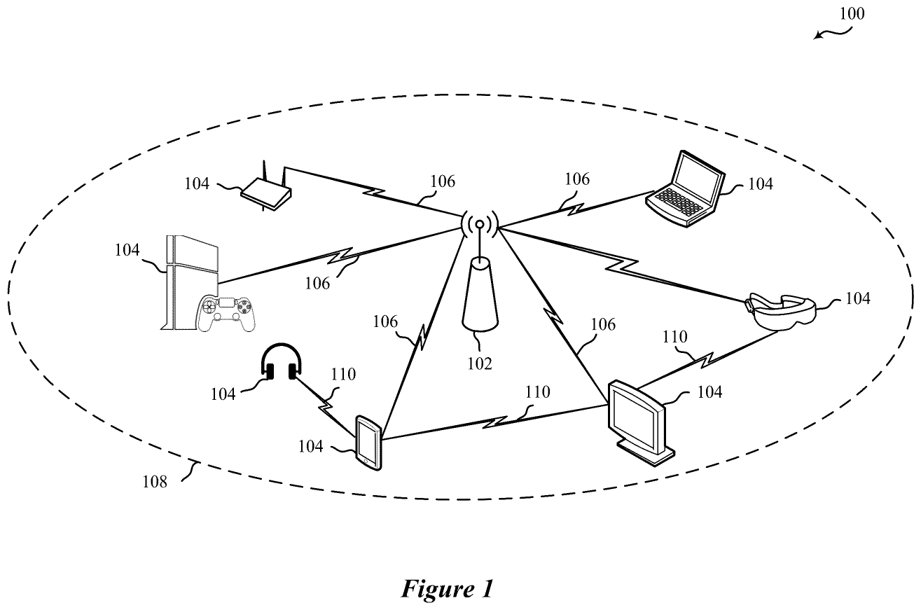

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.1 lax, 802.11 be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

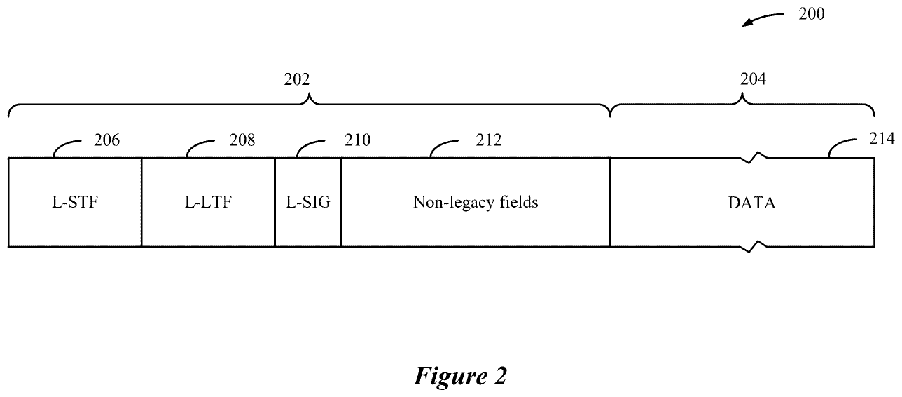

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

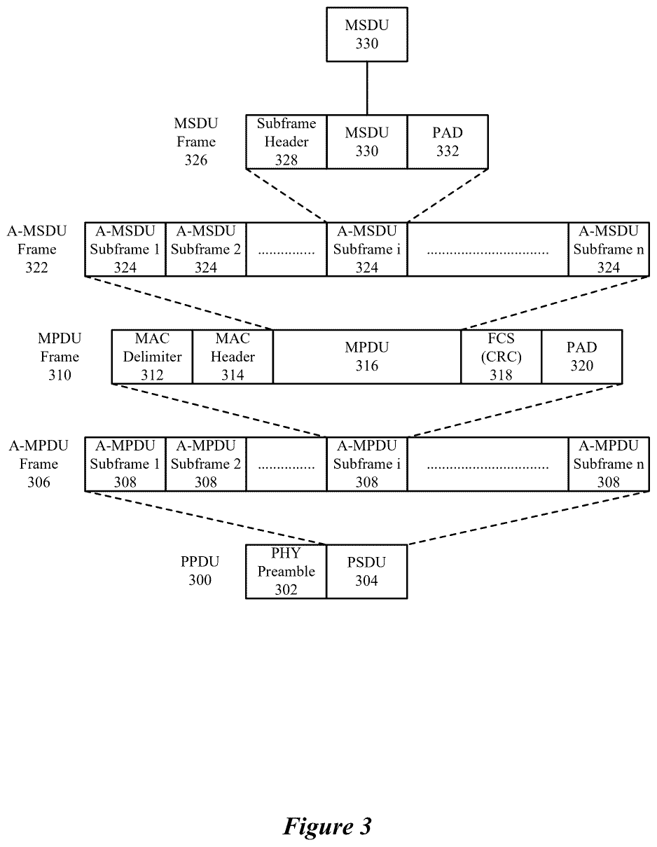

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs). For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

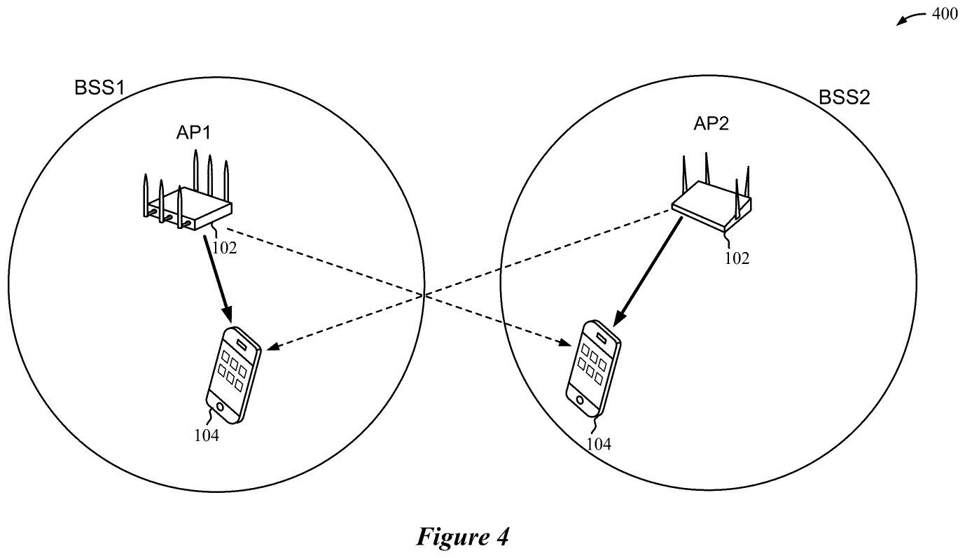

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APs.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

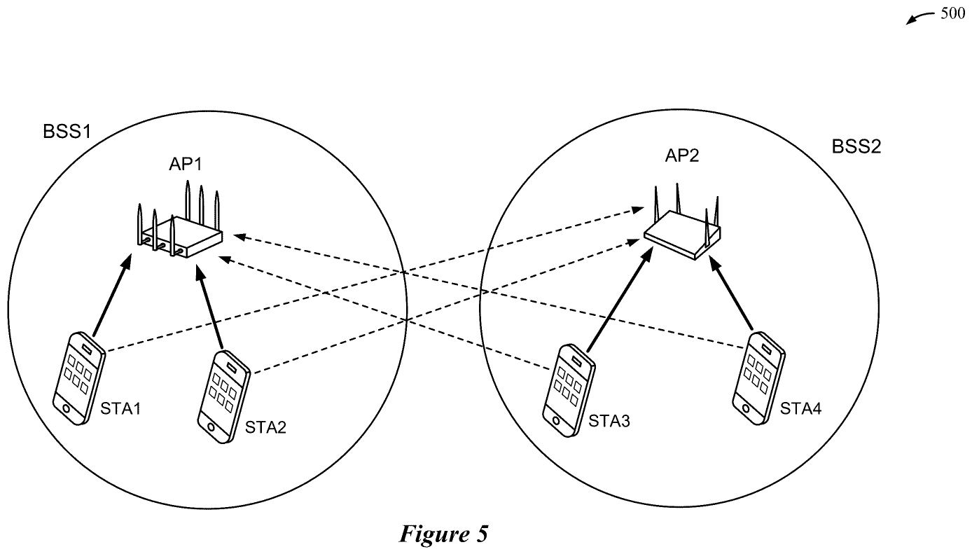

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Example Coordinated Beamformaing

As previously described, in CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized or asynchronized transmission and asymmetric CoBF with synchronized or asynchronized transmission. With symmetric CoBF, all APs may participate in coordinated beamforming and to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (in a same BSS), while an interfering channel may refer to a channel between an OBSS AP and a non-AP STA.

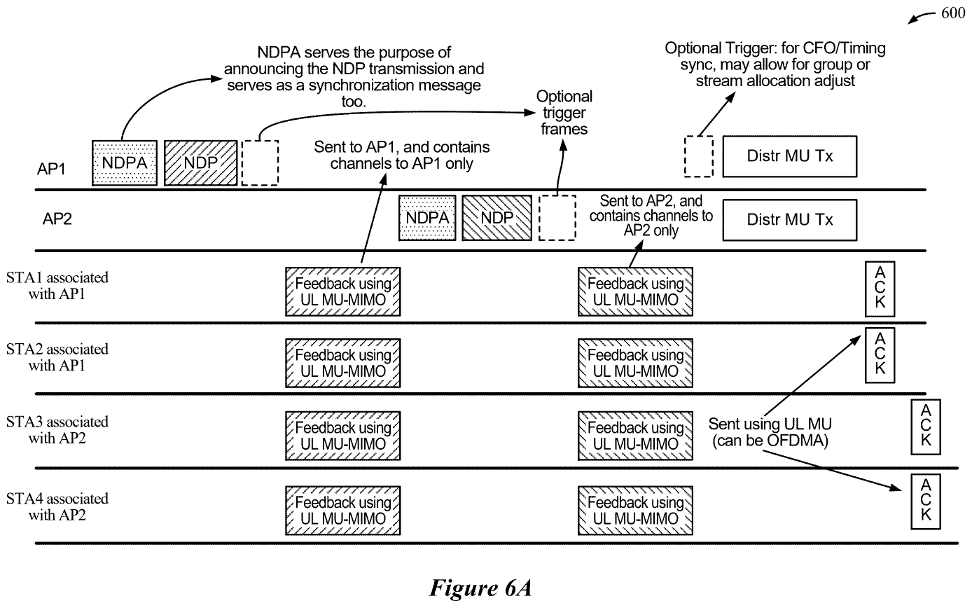

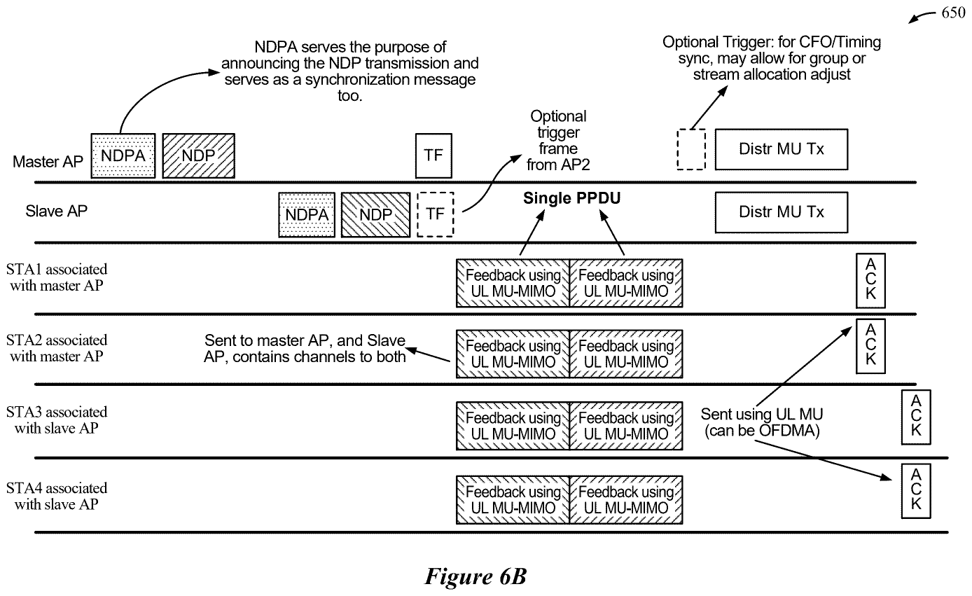

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

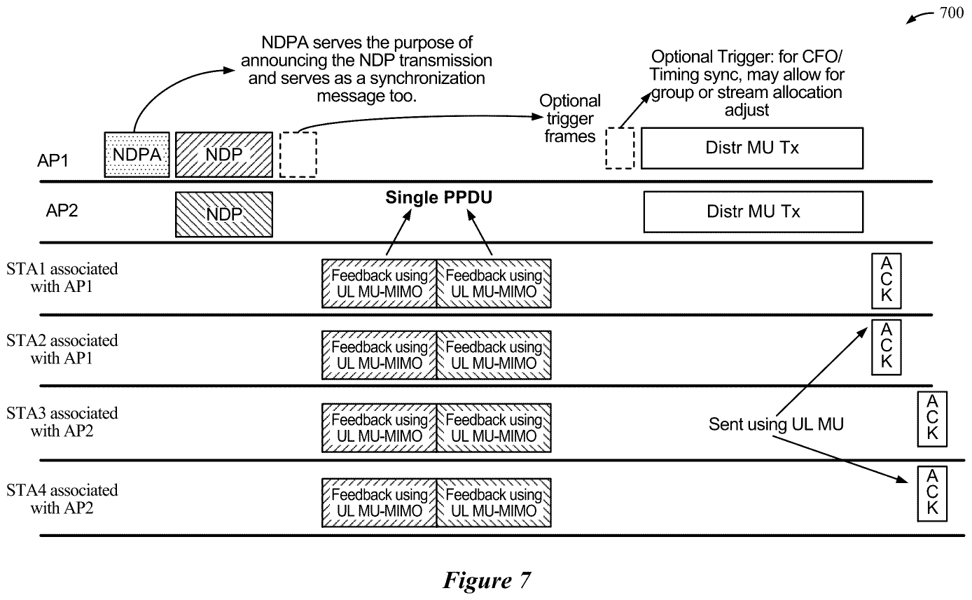

According to a second option, as illustrated in diagram 700 of FIG. 7, APs participating in CoBF collaboratively send out a joint NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams and the streams sent from different APs may use mutually different indices. In this manner, all APs may share a joint LTF, where the first subset of streams are sent from 1st AP, and second subset of streams are sent from a 2nd AP, so that the estimated channel is a composite channel where first subset of streams are from 1st AP and second subset of streams are from 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP.

According to certain aspects of the present disclosure, to aid in CSI processing by a non-AP STA, a joint NDP may indicate which part of composite channel comes from which AP. For example, the joint NDP (or some other signaling mechanism) may signal the numbers of Tx antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . H_{iN}_{ₐₚ}], where each Hij represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback. In some cases, a backhaul (e.g., a light backhaul) between APs may be used for CSI exchange. In such cases, all STAs may send CSI feedbacks to their own APs and the APs may share with each other (exchanging CSI feedback) over the backhaul. In this case, UL transmissions (of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

In this context, point-to-point channel feedback generally refers to the CSI feedback of a channel between two STAs, such as an AP and a non-AP STA (e.g., with a channel matrix Hᵢⱼ for APj and STAi). For point-to-point channel feedback, there are also various sub-options with different types of CSI processing (to generate the CSI feedback) and different types of content fed back (as CSI feedback).

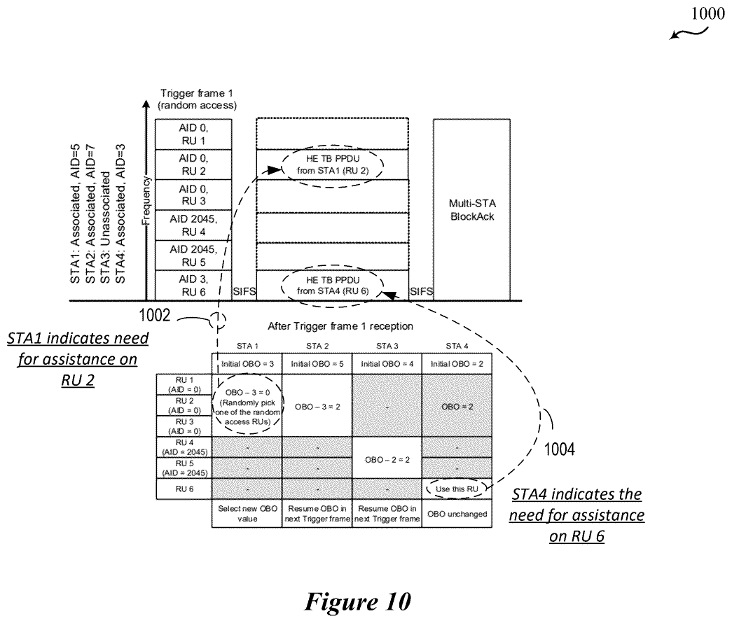

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (APj) to an i-th STA (STAi) may be denoted as Hᵢⱼ where N_{rx,i} is the number (quantity) of receive antennas of APj and N_{tx,j} is the number of transmit antennas from APj (and N_{rx,i}≤N_{tx,j}).

Based on the channel estimation of a packet (e.g., an NDP) from APj, STAi may obtain the channel matrix Hᵢⱼ and perform a singular value decomposition (SVD) on Hᵢⱼ to obtain:

$${H}_{ij} = {U}_{ij} \cdot {S}_{ij} \cdot {V}_{ij}^{′} ,$$

where Uᵢⱼ is an N_{rx,i}N_{rx,i} (left semi-unitary or) unitary matrix, Sᵢⱼ is an N_{rx,i}×N_{rx,i} diagonal matrix with the singular values of the channel Hᵢⱼ, and Vᵢ is an N_{tx,j}×N_{rx,i} (right) semi-unitary (or unitary) matrix.

In some cases, CSI feedback may be what is referred to as small V feedback. With small V feedback, STAi feeds back Sᵢⱼ and Vᵢⱼ of requested rank N_{fb,i}, i.e., S_{fb,ij}=Sᵢⱼ(1:N_{fb,i}, 1:N_{fb,i}) and V_{fb,ij}=Vᵢⱼ(:, 1:N_{fb,i}), where the requested rank may be signaled to the STA in a prior packet, e.g., NDPA. The notation of A(i:j, k:l) represents a submatrix of A, by selecting from the i-th to j-th rows and from the k-th to l-th columns. The notation “:” in a submatrix A(:, k:l) represents a submatrix of A, by selecting all rows and from the k-th to l-th columns. Likewise, the notation “:” in a submatrix A(i:j, :) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel

$${rH}_{ij} = {S}_{fb , ij} \cdot {V}_{fb , ij}^{′}$$

corresponds to the Eigen channels using the

$${U}_{nfb , ij}^{′}$$

receiver (which is not fed back), where U_{nfb,ij}=Uᵢⱼ(:, 1:N_{fb,i}). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

One example of this first sub-option for point-to-point channel CSI processing and feedback may assume AP1 (BSS1) and AP2 (BSS2) transmit NDP(s) for sounding. In such cases, STA1 may generate, based on the NDP(s), CSI FB for intended channel (between AP1 and STA1) based on SVD of original channel and generates CSI FB for interfering channel (between AP2 and STA1) based on an SVD of equivalent channel.

In some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hᵢᵢ is an intended channel and all other Hᵢⱼ where j≠i are interfering channels.

For intended channel Hᵢᵢ, STAi may feed back S_{fb,ii}=Sᵢᵢ(1:N_{fb,i}, 1:N_{fb,i}) and V_{fb,ii}=Vᵢᵢ(:, 1:N_{fb,i}) where N_{fb,i}=N_{ss,i}, where N_{ss,i} is the number of streams for the i-th STA that the i-AP intended to send in the CoBFed transmission, assuming using the eigen receiver

$${U}_{ss , ii}^{′}$$

(not fed back) where U_{ss,ii}=Uᵢᵢ(:, 1:N_{ss,i}).

For interfering channel Hᵢⱼ where ≠i, the equivalent channel assuming the Eigen receiver at the i-th STA is

$${U}_{ss , ii}^{′}$$

so that the equivalent channel from the j-th AP to the i-th STA after this Eigen receiver processing becomes

$${U}_{ss , ii}^{′} {H}_{ij} .$$

For the CSI FB for the interfering channel, STAi may perform SVD on the equivalent channel

$${U}_{ss , ii}^{′} {H}_{ij}$$

to obtain:

$${U}_{ss , ii}^{′} {H}_{ij} = {U}_{ss , ij} \cdot {S}_{ss , ij} \cdot {V}_{ss , ij}^{′} ,$$

where U_{ss,ij} is an N_{ss,i}×N_{ss,i} unitary matrix, S_{ss,ij} is an N_{ss,i}×N_{ss,i} diagonal matrix with the singular values of the equivalent channel

$${U}_{ss , ii}^{′} {H}_{ij} ,$$

and V_{ss,i} is an N_{tx,j}×N_{ss,i} semi-unitary matrix. Feedback S_{fb,ij}=S_{ss,ij}(1:N_{fb,i}, 1:N_{fb,i}) and V_{fb,ij}=V_{ss,ij}(:, 1:N_{fb,i}) where N_{fb,i}=N_{ss,i}.

A distinction between the enhanced small V feedback according to this first sub-option and typical V feedback is that the enhanced feedback (for the interfering channels) is based on the SVD of the equivalent channel

$${U}_{ss , ii}^{′} {H}_{ij}$$

instead of the SVD of the original channel Hᵢⱼ. In this way, the same receiver,

$${U}_{ss , ii}^{′}$$

is assumed for intended and interfering channels. In this example, it is assumed that the Eigen receiver

$${U}_{ss , ii}^{′}$$

is used to generate both the CSI FB for the intended channel Hᵢᵢ and the CSI FB for the interfering equivalent channel

$${U}_{ss , ii}^{′} {H}_{ij} .$$

A more general case in the enhanced feedback is to use a same linear receiver Gᵢ to generate both the CSI FB for the intended equivalent channel GᵢHᵢᵢ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (fed back in this case), S_{fb,ij} and V_{fb,ij}.

In some cases, it may be beneficial to exchange certain information that may be needed for joint NDP via NDPA. In some cases, a STA information (info) field may include a special AID value for a shared AP. In some cases, a sounding dialogue token reserved state might be used to signal that this is a NDPA that signals joint sounding. Such an indication may indicate to an AP (and possibly the STAs) that a joint sounding NDP is going to arrive.

In some cases, such information may be conveyed via a single STA info field. Such a field may be considered a special STA Info Field targeted to an AP in NDPA preceding a joint NDP. In some cases, the special STAID per AP can be advertised in the beacon as some form of AP identifier (which may be a self-chosen IP, referred to as a “CoBF special APID). Collisions may be resolved in a similar manner as BSS color collisions. In some cases, the CoBF special APID may be 11 bits.

For CoBF sounding, an NDPA may still being addressed to an in-BSS STA. There may be no need for changes to a BSS ID (transmitter of the NDPA) and STAID in the STA info field to the target STA. Other information may be conveyed, such as the number of streams (columns) being requested in the feedback is Nc. In some cases, a special STA info field may be addressed to a shared AP. This field may convey the starting and ending stream index for the shared AP and may convey information regarding what rows of the P-matrix to use. The STA info field may use a special AID which is associated with the AP.

In some cases, asymmetric CoBF may be supported, for example, with two 4 Tx APs, each having one active STA. Such an example may assume a secondary BSS has a 2Rx STA and secondary AP intends to transmit 1ss to that station. The example may also assume that the primary STA is explicitly sounded to secondary AP channel and that the primary STA pre-calculates the optimum receive filter and pre-compensates the interference channel feedback to the interfering AP (e.g., to provide a single Eigen mode where interference needs to be nulled).

Various potential issues related to asymmetric CoBF may be addressed. Such issues may be explained considering an example that assumes a 2Rx STA in the primary BSS. In one case, the STA may be receiving 1ss and feeds back a single Eigen mode to secondary BSS. In such cases, there may be joint LTFs, for which we need pre-negotiation of several things between secondary and primary AP. In another case, the STA may receive 2ss. In such cases, 2 Eigen modes may be fed back to the secondary BSS AP.

There are various options for CoBF group formation, in order to determine what APs will participate in CoBF). According to a first option, a sharing AP (e.g., AP1) sends a CoBF opportunity trigger to the APs, an intent to participate, and a final CoBF configuration. The trigger may contain a number of spatial multiplexing dimensions available at sharing AP, a list of APs that AP1 is inviting for CoBF (AP1 sees them as good CoBF candidates). For example, some STAs in BSS1 may get labeled via a background process as good candidates for CoBF with AP2 and AP3. A trigger may also indicate resources for transmitting an intent to participate. The intent to participate (transmitted using TB PPDU) may contain a number of spatial multiplexing dimensions (or number of antennas) available at shared AP and indicate to a responding AP (e.g., AP2 and AP3) STAs which are good candidates for CoBF with AP1. The final CoBF configuration may contain an identifier for the AP (s) in 2-AP groups as shared AP (s) for CoBF with sharing AP1.

According to another option for CoBF group formation, every AP may advertise various information in the beacon. Such information may include, for example, spatial multiplexing capability (maybe equal to the number of antennas) for CoBF and a list of good candidate neighboring APs for CoBF. In some cases, this list may get updated in the beacon based on the in-BSS background process. In some cases, there may be no explicit group formation phase. Rather group formation may begin directly with the sounding phase with one AP acting as sharing AP.

There are various options for resolving collisions of CoBF AP1D with STAID in the first option described above. For example, if AP2 picks a CoBF AP1D which matches STA1's ID, various information may be signaled in the NDPA. Such information may include, for example, that the NDP is a UHR variant of NDP and/or is a joint sounding NDP (e.g., via reserved state in sounding dialogue token). Such information may notify the STA1 and AP2 that there is a STA info field that is meant for AP2 at a fixed location (e.g., either the first or the last STA info field in the NDPA). In some cases, the STA may ignore that STA info field even if the STAID matches.

In some cases, such signaling may also be used by AP2, for example, to determine that an NDPA is a special NDPA, which prompts AP2 to send an NDP in response. The signaling may also notify AP2 that it needs to look for a special STA info field at either the beginning or the end.

### Coordinated AP Traffic Indication and Polling

As noted above, CAP mechanisms may involve one or a combination of C-TDMA (C-TWT and/or C-RTWT) to coordinate resources in the time domain, C-BF (or CoBF) or C-SR to coordinate resources in the spatial domain which may involve long-term negotiation/coordination between two or more OBSS APs. In some cases, for some CAP features, such coordination may be on a per-TXOP basis (in addition to some long-term negotiation).

In general, these mechanisms involve (sharing and one or more shared) APs coordinating with each other to improve the overall system performance. For example, in C-TDMA, a sharing AP shares a portion of time of its acquired TXOP with shared AP(s). In C-BF, a sharing AP and shared AP(s) null each other's interference at their respective clients. In C-SR, a sharing AP and shared AP(s) perform spatial reuse in a coordinated fashion.

In C-TDMA, C-BF, and C-SR, the sharing AP initiates the coordination by transmitting a frame (a.k.a. an initial Control frame, ICF). Each scheme typically has scheme-specific requirements that this ICF must meet. After an ICF (or ICF and ICF response exchange), the shared AP(s) participate in the coordinated TXOP and “flush” their respective queues and service their associated clients.

As noted above, in some cases, it may be assumed that the sharing AP has some knowledge that a shared AP (or shared APs) need assistance. This may be achievable, for example, if the sharing AP and shared AP(s) have tight backhaul coordination such as in enterprise networks. However, in some environments such a tight coordination may not be feasible, and the sharing AP may be generally unaware of whether the shared AP(s) need assistance.

Aspects of the present disclosure provide techniques and mechanisms that may allow an AP (e.g., a shared AP) to indicate a need for assistance. Via such mechanisms, a shared AP may indicate that it is a candidate to benefit from participating in a CAP scheme with a sharing AP.

While certain CAP mechanisms are described herein as illustrative examples, the techniques described herein may more broadly be applied to any such (e.g., current or future) mechanism (e.g., or combination of mechanisms) that requires APs to coordinate with each other.

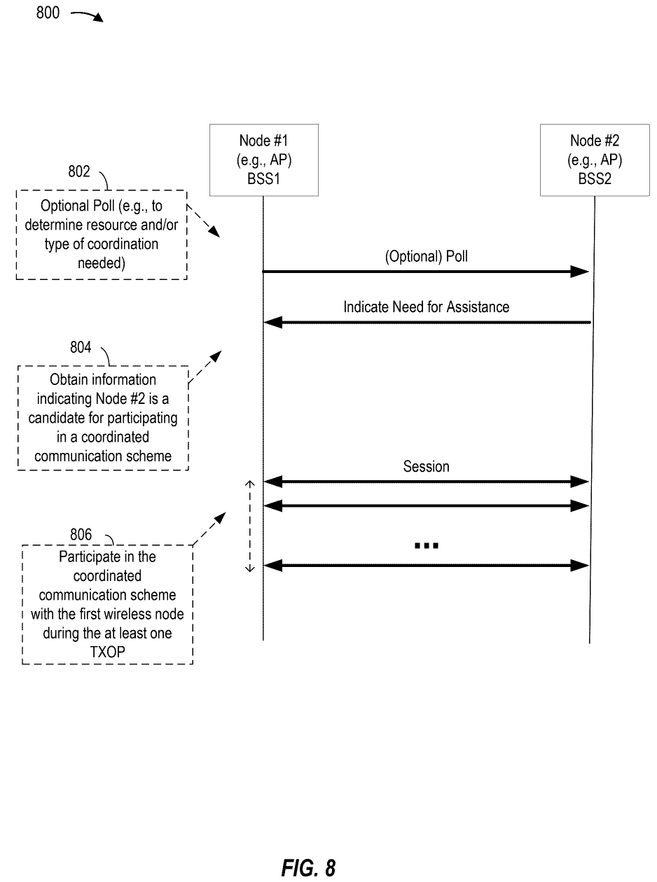

The signaling mechanisms proposed herein may be understood with reference to call flow diagram 800 of FIG. 8.

In some aspects, the first wireless node (Node #1) shown in FIG. 8 may be a sharing AP (e.g., an example of an AP 102 depicted and described with respect to FIG. 1). In some aspects, the second wireless node (Node #2) shown in FIG. 8 may be a shared AP or a non-AP STA (e.g., an example of an AP 102 or a STA 104 depicted and described with respect to FIG. 1). As indicated, Node #1 may be associated with a first BSS (BSS 1) and Node #2 may be associated with a second BSS (BSS 2).

As illustrated at 804, Node #2 may signal information indicating that it is a candidate for participating (e.g., might benefit from participating) in a coordinated communication scheme (e.g., a CAP or MAP-C or MAPC scheme) with Node #1. As will be described in greater detail below, there are various options for how this information is provided. In some cases, this information may be provided via a shared AP. As illustrated at 806, Node #1 and Node #2 may participate in the coordinated communication scheme during at least one TXOP.

As indicated at 802, in some cases, Node #1 may poll Node #2 to determine resource needs (e.g., buffer status) of Node #2 or a type of coordination Node #2 potentially needs (e.g., what type of CAP scheme) or one or more parameters associated with a coordination scheme Node #2 potentially needs (e.g., a quantity of time to be shared with Node #2).

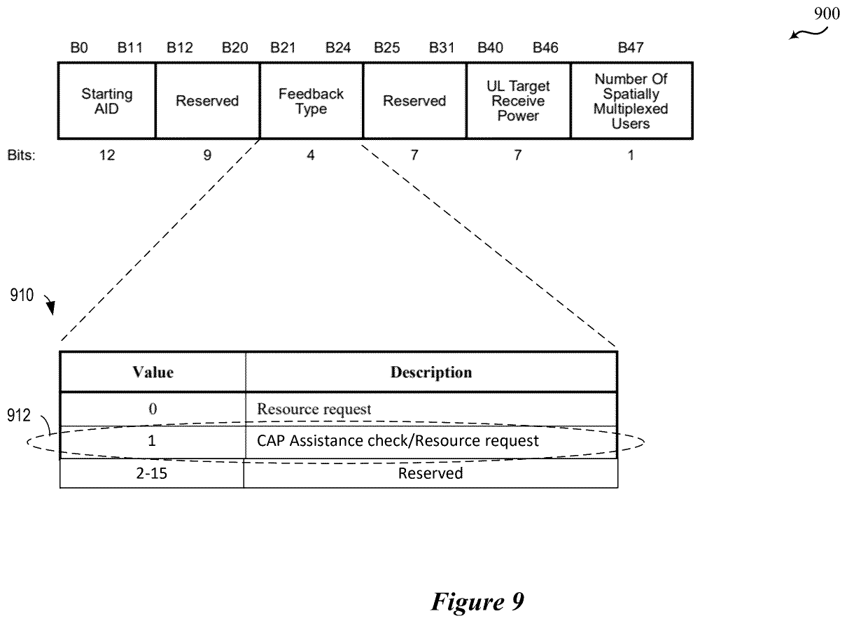

As illustrated at 912 in FIG. 9, in some cases, the polling may be indicated via a particular value (1 in the illustrated example) in a feedback type field 910 of a Network Feedback Report Poll (NFRP) Trigger frame 900. An NFRP Trigger frame is a type of control frame used to trigger the transmission of feedback regarding a specific uplink transmission (e.g., based on the received signal quality related to a previous transmission).

In some cases, a sharing AP may poll one or more shared APs and the information may be obtained in response to such polling. In some cases, a sharing AP may poll one or more shared APs after obtaining information indicating the (potential) need for assistance. In such cases, the sharing AP may use the polling to request more detailed information to prepare for participating in a CAP scheme with the shared AP(s).

An AP (e.g., Node #2 in FIG. 8) can signal in one or more of its transmitted frames that it might need (require) assistance via (from participating in) a CAP mechanism. This indication may be provided in Management, Control or Data frames transmitted by the AP.

Depending on the frame, a specific field may be set to a special value that indicates a need for assistance.

For management frames (e.g., Beacons and Probe Response frames or an Action frame), the AP may set a specific bit(s) to a special value to indicate need for assistance. For example, the AP may set specific AID(s) fields to a certain value (e.g., “1”) in the TIM element to indicate need for assistance. In some cases, these AID(s) may correspond to the AP identifier value assigned to the neighboring APs during MAPC negotiation. Alternatively, there may be one or more field(s) defined in a CAP or MAPC element that signals the need for assistance. A need for assistance may also be indicated via a broadcast frame referred to as a CAP Notification or a MAPC Advertisement/Discovery frame. The management frame may be broadcast or sent as an individually addressed frame to a specific neighboring AP.

For control frames, if the AP transmits a trigger frame (e.g., an ICF or MU-RTS TXS) then the AP may indicate a need for assistance in a common information (Info) or one or more Special User information field(s) of the trigger frame.

In some cases, the indication may be provided via a user (specific) information field directed to a specific AP. This may be understood with an example that assumes AP1 is the current sharing AP. When sending an ICF to AP2 (a current shared AP), AP1 can indicate in the user Info field assigned (such as addressed) for AP2 that it may need assistance (such as TXOP sharing) from AP2.

In some cases, the indication may be provided via a Multi-STA Block Ack (M-BA) frame (such as transmitted in response to MPDUs sent by associated STAs). In such cases, specific field(s) in the M-BA frame may signal this indication (e.g., BA Control, AID-TID Info, Block Ack Starting Sequence Control, or the Block Ack bitmap fields).

If a sharing AP shares the TXOP via C-TDMA, then the indication may be provided via a TXOP return frame. In some cases, the indication may be provided via a response to being polled by another AP.

For data, management or control frames, the indication may be provided via a U-SIG or UHR-SIG field of the PHY preamble. As an alternative (or in addition), the indication may be provided via a field of the MAC header such as an A-Control field.

These indications (e.g., of a need for assistance) may be feature-specific or general. For example, an AP may indicate that it needs assistance via a specific CAP feature (e.g., C-TDMA or C-SR). Alternatively, the AP may send a general indication that it needs assistance via some type of CAP feature (e.g., without specifying the particular coordination feature itself).

Similarly, the indication of a need for assistance may be global (e.g., accepting help from any AP) or AP-specific (e.g., accepting help from one or more specific AP(s)). If the indication is global, any AP that hears the indication may be able to help. Alternatively, the need for assistance may be signaled to one or more specific (neighboring) APs. For example, in TIM element based signaling for assistance, the bit position corresponding to a specific AP ID may be set to 1 to indicate that assistance is needed from that specified neighboring AP. If the indication is AP-specific, the specific AP(s) might be recommended to provide assistance to the indicating AP via one or more MAPC schemes. In some cases, an indicating AP might penalize the neighboring AP(s) if it does not receive an assistance upon requesting assistance. The penalty may be in the form of not coordinating with the neighboring AP(s) (e.g., for a specific quantity of time) or terminating a MAPC negotiation, MAPC session, or a MAPC setup.

In some cases, the indication of a need for assistance may be provided between APs belonging to different collocated BSSID Sets (e.g., a combination of MBSSID Set and co-hosted BSSID Set). In such cases, one AP from one collocated BSSID set may indicate the need to another AP from a different collocated BSSID Set.

In some cases, the indication of need for assistance may be provided by any STA (e.g., including a non-AP STA). For example, it may be the AP that needs assistance or one or more of its associated STA(s). It may also be other APs that the first AP is coordinating with. For example, when AP2 hears AP1 needs assistance (e.g., by decoding the M-BA frame(s) from AP1), AP2 may include an indication in its M-BA frames, Trigger frames, Data frames, Management frames, or any combination thereof, that indicates AP1 needs assistance.

In some cases, the indication of need for assistance may be internal, limited to APs within the collocated BSSID Set (e.g., a combination of MBSSID Set and co-hosted BSSID Set). In such cases, the shared AP may be collocated with the sharing AP (as part of the collocated BSSID Set) and the indication can be internal to the device or via a controller managing those set of collocated APs.

In certain scenarios, the indication of a need for assistance may be based on pending buffered units or prior knowledge of upcoming traffic. For example, in certain Wi-Fi systems, a non-AP STA may offload artificial intelligence or machine learning (AIML) inferencing to its associated APs. In such cases, depending on the type of AIML model(s) being executed at the AP, there may be a significant amount of traffic that the AP needs to flush out in a relatively short interval.

For example, if an AP receives an inferencing request and knows that the payload corresponding to an inference response will need a lot of resources to flush, the AP may indicate a need for assistance even before the inference response is ready to transmit. In such cases, the AP may send an indication of a need for assistance in an acknowledgement frame (e.g., via an M-BA) sent in response to the inference request. Such examples may be common when a non-AP offloads a multi-modal AIML model(s) to the AP (such as inference request carrying a text prompt that generates image/video inference response from the AP).

The indication of need for assistance may be provided for the same link on which the frame carrying the indication is transmitted or on a different link. In such cases, the AP may indicate the link ID(s) of the link(s) on which it needs assistance.

For example, in a CAP notification frame transmitted by an AP, in addition to indicating that the AP needs assistance, the AP may include an information element (IE), such as a multi-link link IE, to signal the link ID(s) of the link(s) on which the AP needs assistance. Alternatively, in the A-Control field of the MAC header of the Data frames transmitted by an AP, the AP may include a bitmap to signal the link ID(s) of the link(s) on which it needs assistance.

In some cases, an AP may have traffic for subset of TIDs that are mapped to a subset of links and the AP may win access on a link which is not part of the subset. In such cases, the AP may signal an indication that it could use (benefit from) help for those subset of links.

Certain additional mechanisms may be defined, or existing mechanisms may be reused, that enable an AP to indicate a need for assistance. For example, an AP may transmit a trigger frame that signals the presence of one or more Random Access Resource Units (RA-RUs) that neighboring APs are allowed to use for uplink OFDM random access (UORA). In such cases, a neighboring AP may indicate a need for assistance in the RA-RUs.

An example of this scenario is shown in diagram 1000 of FIG. 10. As illustrated, a trigger frame (Trigger frame 1) may act as an ICF/polling frame to one or more neighboring AP(s) and one or more associated non-AP STAs. RUs used for RA may be signaled using a special AID value (e.g., nonzero and >2007). In the illustrated example, RU 4 and RU 5 are indicated as RA RUs (via AID 2045). As illustrated, other RUs may be used to indicate a need for assistance. In the illustrated example, STA1 indicates a need for assistance on RU2 (as indicated at 1002), while STA4 indicates a need for assistance on RU6 (as indicated at 1004).

As noted above with reference to FIG. 9, in some cases one or more values (e.g., value “1”) of a Feedback Type field 910 may be used to indicate “CAP resource request” or “CAP assistance check.” In such cases, when an AP transmits an NFRP Trigger frame with the Feedback Type field set to this value, the responding AP may send a binary indication (of a need for assistance) in the allocated resources (e.g., where a response value of 1 may indicate a need for assistance, while a response value of 0 may indicates no need for assistance).

In certain systems (e.g., 802.11bn) a pre-emption feature may be implemented, which allows non-AP STAs, based on allowance from the AP, to pre-empt ongoing DL traffic. In such systems, this mechanism may be extended such that neighboring APs may pre-empt an ongoing DL TXOP. The TXOP holder AP may indicate whether the pre-emptible TXOP can be pre-empted by associated STAs, neighboring APs, or both.

As noted above, with reference to the call flow diagram 800 of FIG. 8, in some cases, an AP may poll neighboring APs (to determine their resource/assistance needs). For example, when an AP acquires a TXOP, it may poll other APs in its neighborhood to determine which AP(s) it needs to coordinate with.

In some cases, the polling frame exchange may be performed in the initial portion of the TXOP. In response to being polled, the polled AP may provide various information, such as a binary indication that it needs assistance via coordination and/or which coordination mechanism (e.g., C-SR, C-BF, C-TDMA) it currently needs. In some cases, which coordination mechanism it currently needs may be based on the polled AP's associated STAs' relative locations, channel conditions, traffic requirements, or buffer occupancy. Thus, the same polled AP may indicate a different coordination mechanism when it is polled by different polling APs. The polled AP may also indicate how soon after being polled the polled AP needs the coordinated TXOP (e.g., based on a delay budget).

After polling is completed, the polling AP may coordinate with the other APs in the same TXOP or in a future TXOP. The decision to coordinate in the same TXOP or in a future TXOP may be based at least in part on the delay budget indicated by the polled AP.

As noted above, in some cases, the polling may be in response to the explicit indication provided by the neighboring APs, indicating that they need assistance via CAP mechanisms. In general, however, an AP may poll one or more neighboring APs in any TXOP (e.g., every TXOP) to determine whether (and which) APs in the neighborhood need coordination.

In some cases, the polling frame and the response frame may be a BSRP Trigger frame and the Multi-STA Block Ack (M-BA) frame, respectively. In such cases, the M-BA frame may be solicited in a Trigger-based (TB PPDU) or a non-HT (duplicate) PPDU format. The decision to solicit the M-BA frame in a specific PPDU format may be based on the capability of the polled AP(s).

In some cases, if the polled AP(s) support generating TB PPDUs, then in the polling frame exchange sequence, the polling AP may address a mix of neighboring APs (that need coordination) and associated non-AP STAs. In such cases, these associated STAs may be operating in certain modes that require an ICF. Such modes may include, for example, an enhanced multi-link single radio (eMLSR) mode, dynamic subband operation mode, In-device coexistence mode, or a dynamic power save mode. In some cases, the polling AP may poll the neighboring APs on a non-primary channel access (NPCA) primary channel.

In some cases, if the polled AP does not support generating TB PPDUs, then the polling AP may sequentially poll one or more APs in the same TXOP.

In some cases, the polling AP may poll only those APs that have provided some indication of need for assistance. For example, if a neighboring AP (AP2) has provided a binary indication of need for assistance, the polling AP (AP1) may poll AP2 to determine additional information (such as type of assistance needed, e.g., which mechanism). However, AP1 may decide to not poll another neighboring AP (AP3) that has not provided any binary indication of need for assistance.

In some cases, an AP may need assistance (or a certain type of assistance) for a given time period. Therefore, there may be a time constraint between when an AP is polled and when the TXOP is coordinated with the polled AP using one of the CAP schemes. This constraint may be local to the polling AP, indicated by the polled AP(s), or both.

### Example Methods

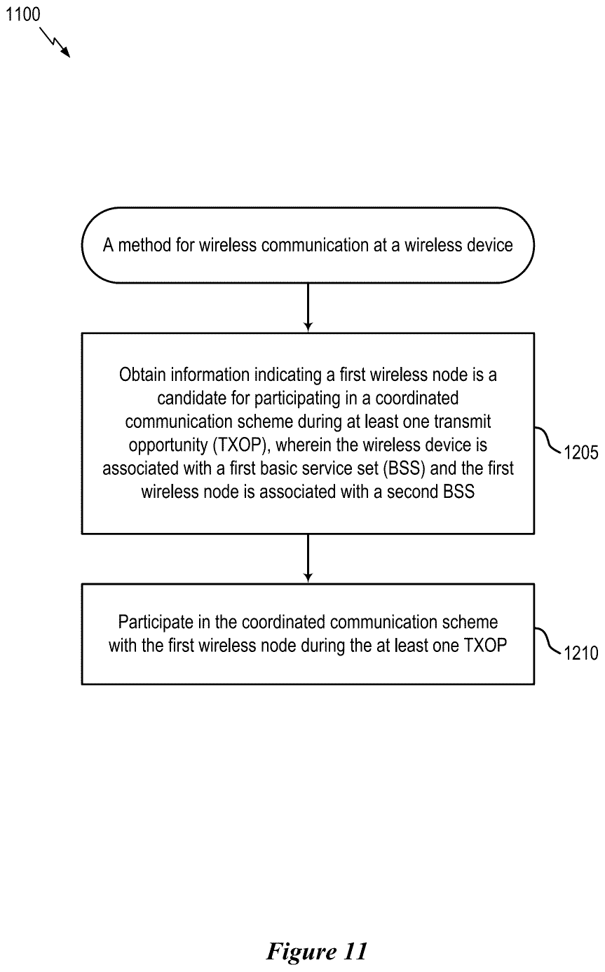

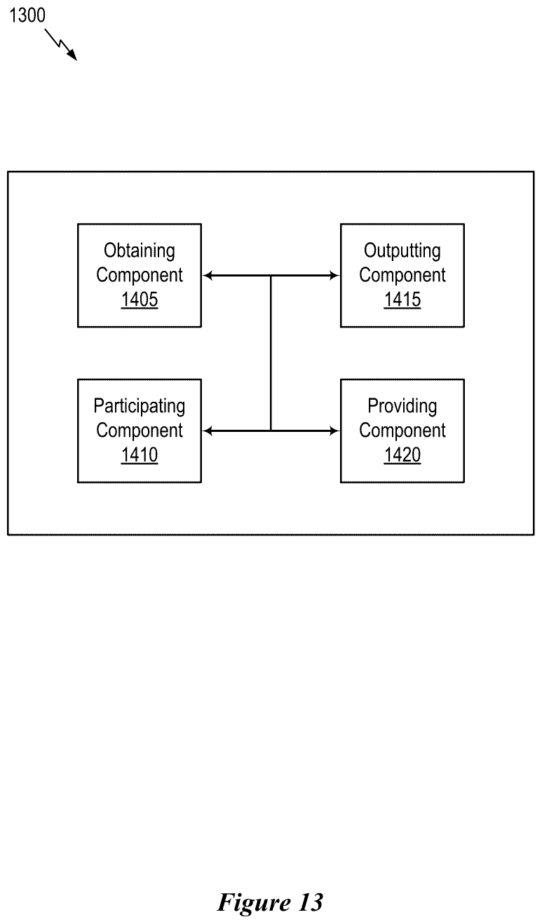

FIG. 11 shows a flowchart illustrating an example process 1100 performable by or at a wireless device. The operations of the process 1100 may be implemented by a wireless STA, or its components as described herein, and/or wireless AP, or its components as described herein. For example, the process 1100 may be performed by a wireless communication device, such as the wireless communication device 1300 described with reference to FIG. 13, operating as or within a wireless STA or operating as or within a wireless AP. In some examples, the process 1100 may be performed by a wireless STA such as one of the STAs 104 described with reference to FIG. 1. In some examples, the process 1100 may be performed by a wireless AP such as one of the APs 102 described with reference to FIG. 1.

In some examples, in block 1105, the wireless device may obtain information indicating a first wireless node is a candidate for participating in a coordinated communication scheme during at least one transmit opportunity (TXOP), wherein the wireless device is associated with a first basic service set (BSS) and the first wireless node is associated with a second BSS. In some cases, the operations of this step refer to, or may be performed by, an obtaining component as described with reference to FIG. 13.

In some examples, in block 1110, the wireless device may participate in the coordinated communication scheme with the first wireless node during the at least one TXOP. In some cases, the operations of this step refer to, or may be performed by, a participating component as described with reference to FIG. 13.

In some aspects, the coordinated communication scheme involves at least one of: coordinated beamforming (COBF), coordinated spatial reuse CSR), or coordinated time division multiple access (C-TDMA).

In some aspects, the information is obtained via at least one first frame comprising at least one of a management frame, control frame, or data frame.

In some aspects, the information is conveyed via a field of the at least one first frame, the field being associated with a value that indicates the first wireless node could benefit from participating the coordinated communication scheme.

In some aspects, the information further indicates a particular type of coordinated communication scheme the first wireless node could benefit from.

In some aspects, the information identifies at least one of: the wireless device; a set of BSS identifiers (BSSIDs) including the first BSS; or a set of BSSIDs including both the first BSS and the second BSS.

In some aspects, the information is obtained from at least one of: the first wireless node; a wireless station associated with the first wireless node; or a second wireless node associated with a third BSS.

In some aspects, the information further indicates the first wireless node has pending buffered data or anticipates upcoming traffic.

In some aspects, the information is obtained in a first frame that is an inference request or acknowledges an inference request.

In some aspects, the information is obtained via a first communication link; and the information further indicates the first wireless node could benefit from participating in the coordinated communication scheme via at least one of the first communication link or a second communication link.

In some aspects, the information further indicates a set of one or more communication links via which the first wireless node could benefit from participating in the coordinated communication scheme.

In some aspects, the information is obtained via at least one of: one or more random access resource units (RA-RUs); a response to a feedback report poll trigger frame; or resources indicated as preemptible by the first wireless node in the at least one TXOP or another TXOP associated with the wireless device.

In some aspects, the process 1100 further includes outputting a first frame to poll for one or more wireless nodes that could benefit from participating in the coordinated communication scheme. In some cases, the operations of this step refer to, or may be performed by, an outputting component as described with reference to FIG. 13.

In some aspects, the information is obtained via a response to the first frame; or the first frame is output after obtaining the information.

In some aspects, the first frame comprises a feedback report poll trigger frame; and the information is obtained via a response to the feedback report poll trigger frame.

In some aspects, the first frame addresses at least one of: one or more access points (APs); or one or more non-AP wireless stations.

In some aspects, the participation in the coordinated communication scheme with the first wireless node, identified via a response to the first frame, is subject to a time constraint.

In some aspects, the information further indicates at least one of: a binary indication the first wireless node could benefit from the coordinated communication scheme; a particular type of the coordinated communication scheme the first wireless node could benefit from; or timing information indicating when the first wireless node could benefit from the coordinated communication scheme.

Note that FIG. 11 is just one example of a process, and other processes including fewer, additional, or alternative steps are possible consistent with this disclosure.

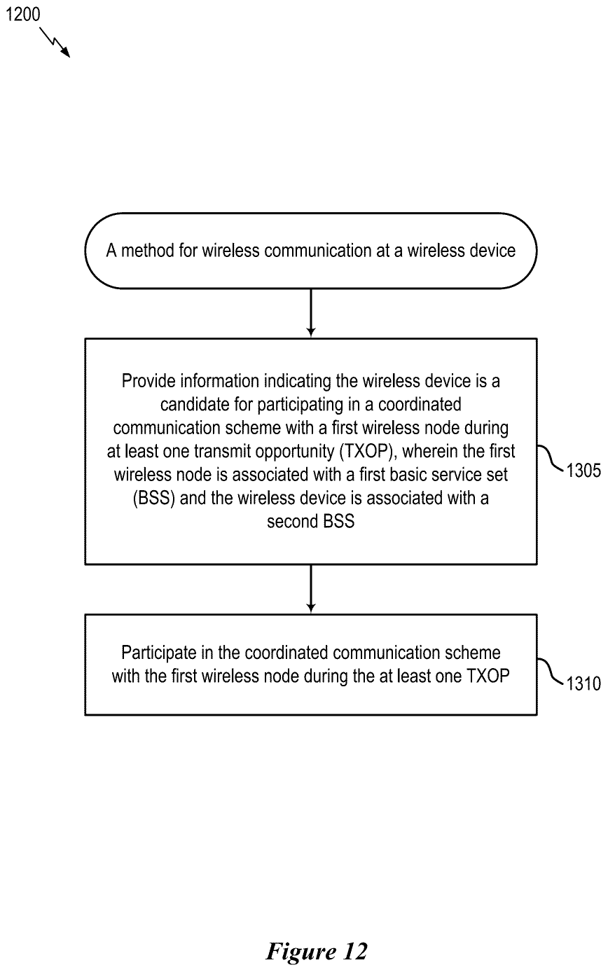

FIG. 12 shows a flowchart illustrating an example process 1200 performable by or at a wireless device. The operations of the process 1200 may be implemented by a wireless STA, or its components as described herein, and/or wireless AP, or its components as described herein. For example, the process 1200 may be performed by a wireless communication device, such as the wireless communication device 1300 described with reference to FIG. 13, operating as or within a wireless STA or operating as or within a wireless AP. In some examples, the process 1200 may be performed by a wireless STA such as one of the STAs 104 described with reference to FIG. 1. In some examples, the process 1200 may be performed by a wireless AP such as one of the APs 102 described with reference to FIG. 1.

In some examples, in block 1205, the wireless device may provide information indicating the wireless device is a candidate for participating in a coordinated communication scheme with a first wireless node during at least one transmit opportunity (TXOP), wherein the first wireless node is associated with a first basic service set (BSS) and the wireless device is associated with a second BSS. In some cases, the operations of this step refer to, or may be performed by, a providing component as described with reference to FIG. 13.

In some examples, in block 1210, the wireless device may participate in the coordinated communication scheme with the first wireless node during the at least one TXOP. In some cases, the operations of this step refer to, or may be performed by, a participating component as described with reference to FIG. 13.

In some aspects, the coordinated communication scheme involves at least one of: coordinated beamforming (COBF), coordinated spatial reuse CSR), or coordinated time division multiple access (C-TDMA).

In some aspects, the information is provided via at least one first frame comprising at least one of a management frame, control frame, or data frame.

In some aspects, the information is provided via a field of the at least one first frame, the field being associated with a value that indicates the wireless device could benefit from participating the coordinated communication scheme.

In some aspects, the information further indicates a particular type of coordinated communication scheme the wireless device could benefit from.

In some aspects, the information identifies at least one of: the first wireless node; a set of BSS identifiers (BSSIDs) including the first BSS; or a set of BSSIDs including both the first BSS and the second BSS.

In some aspects, the information is provided to at least one of: the first wireless node; a wireless station associated with the wireless device; or a second wireless node associated with a third BSS.

In some aspects, the information further indicates the wireless device has pending buffered data or anticipates upcoming traffic.

In some aspects, the information is provided in a first frame that is an inference request or acknowledges an inference request.

In some aspects, the information is provided via a first communication link; and the information further indicates the wireless device could benefit from participating in the coordinated communication scheme via at least one of the first communication link or a second communication link.

In some aspects, the information further indicates a set of one or more communication links via which the wireless device could benefit from participating in the coordinated communication scheme.

In some aspects, the information is provided via at least one of: one or more random access resource units (RA-RUs); a response to a feedback report poll trigger frame; or resources indicated as pre-emptible by the wireless device in the at least one TXOP or another TXOP associated with the first wireless node.

In some aspects, the process 1200 further includes obtaining a first frame from the first wireless node, wherein the information is provided via a response to the first frame. In some cases, the operations of this step refer to, or may be performed by, an obtaining component as described with reference to FIG. 13.

In some aspects, the first frame comprises a feedback report poll trigger frame.

In some aspects, the participation in the coordinated communication scheme with the first wireless node, identified via a response to the first frame, is subject to a time constraint.

In some aspects, the information further indicates at least one of: a binary indication the wireless device could benefit from the coordinated communication scheme; a particular type of the coordinated communication scheme the wireless device could benefit from; or timing information indicating when the wireless device could benefit from the coordinated communication scheme.

Note that FIG. 12 is just one example of a process, and other processes including fewer, additional, or alternative steps are possible consistent with this disclosure.

### Example Device(s)

FIG. 13 shows a block diagram of an example wireless communication device 1300. In some examples, the wireless communication device 1300 is configured to perform the process 1100 described with reference to FIG. 11. In some examples, the wireless communication device 1300 is configured to perform the process 1200 described with reference to FIG. 12. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in a STA, such as the STA 104 described with reference to FIG. 1. In some other examples, the wireless communication device 1300 can be a STA that includes such a processing system and other components including multiple antennas. In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes a user interface (UI) (such as a touchscreen or keypad) and a display, which may be integrated with the UI to form a touchscreen display that is coupled with the processing system. In some examples, the wireless communication device 1300 may further include one or more sensors such as, for example, one or more inertial sensors, accelerometers, temperature sensors, pressure sensors, or altitude sensors, that are coupled with the processing system. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes obtaining component 1305, participating component 1310, outputting component 1315, and providing component 1320. Portions of one or more of the components 1305, 1310, 1315, and 1320 may be implemented at least in part in hardware or firmware. For example one or more of the components 1305, 1310, 1315, and 1320 may be implemented at least in part by a processor or a modem. In some examples, portions of one or more of the components 1305, 1310, 1315, and 1320 may be implemented at least in part by a processor and software in the form of processor-executable code stored in a memory.

### Example Clauses

Clause 1: A method for wireless communication at a wireless device, including: obtaining information indicating a first wireless node is a candidate for participating in a coordinated communication scheme during at least one transmit opportunity (TXOP), wherein the wireless device is associated with a first basic service set (BSS) and the first wireless node is associated with a second BSS; and participating in the coordinated communication scheme with the first wireless node during the at least one TXOP.

Clause 2: The method of Clause 1, where the coordinated communication scheme involves at least one of: coordinated beamforming (COBF), coordinated spatial reuse CSR), or coordinated time division multiple access (C-TDMA).

Clause 3: The method any one of Clauses 1-2, where the information is obtained via at least one first frame including at least one of a management frame, control frame, or data frame.

Clause 4: The method of Clause 3, where the information is conveyed via a field of the at least one first frame, the field being associated with a value that indicates the first wireless node could benefit from participating the coordinated communication scheme.

Clause 5: The method any one of Clauses 1-4, where the information further indicates a particular type of coordinated communication scheme the first wireless node could benefit from.

Clause 6: The method any one of Clauses 1-5, where the information identifies at least one of: the wireless device; a set of BSS identifiers (BSSIDs) including the first BSS; or a set of BSSIDs including both the first BSS and the second BSS.

Clause 7: The method any one of Clauses 1-6, where the information is obtained from at least one of: the first wireless node; a wireless station associated with the first wireless node; or a second wireless node associated with a third BSS.

Clause 8: The method any one of Clauses 1-7, where the information further indicates the first wireless node has pending buffered data or anticipates upcoming traffic.

Clause 9: The method any one of Clauses 1-8, where the information is obtained in a first frame that is an inference request or acknowledges an inference request.

Clause 10: The method any one of Clauses 1-9, where the information is obtained via a first communication link; and the information further indicates the first wireless node could benefit from participating in the coordinated communication scheme via at least one of the first communication link or a second communication link.

Clause 11: The method any one of Clauses 1-10, where the information further indicates a set of one or more communication links via which the first wireless node could benefit from participating in the coordinated communication scheme.

Clause 12: The method any one of Clauses 1-11, where the information is obtained via at least one of: one or more random access resource units (RA-RUs); a response to a feedback report poll trigger frame; or resources indicated as preemptible by the first wireless node in the at least one TXOP or another TXOP associated with the wireless device.

Clause 13: The method any one of Clauses 1-12, further including: outputting a first frame to poll for one or more wireless nodes that could benefit from participating in the coordinated communication scheme.

Clause 14: The method of Clause 13, where the information is obtained via a response to the first frame; or the first frame is output after obtaining the information.

Clause 15: The method of Clause 13, where the first frame includes a feedback report poll trigger frame; and the information is obtained via a response to the feedback report poll trigger frame.

Clause 16: The method of Clause 13, where the first frame addresses at least one of: one or more access points (APs); or one or more non-AP wireless stations.

Clause 17: The method of Clause 13, where the participation in the coordinated communication scheme with the first wireless node, identified via a response to the first frame, is subject to a time constraint.

Clause 18: The method any one of Clauses 1-17, where the information further indicates at least one of: a binary indication the first wireless node could benefit from the coordinated communication scheme; a particular type of the coordinated communication scheme the first wireless node could benefit from; or timing information indicating when the first wireless node could benefit from the coordinated communication scheme.

Clause 19: A method for wireless communication at a wireless device, including: providing information indicating the wireless device is a candidate for participating in a coordinated communication scheme with a first wireless node during at least one transmit opportunity (TXOP), wherein the first wireless node is associated with a first basic service set (BSS) and the wireless device is associated with a second BSS; and participating in the coordinated communication scheme with the first wireless node during the at least one TXOP.

Clause 20: The method of Clause 19, where the coordinated communication scheme involves at least one of: coordinated beamforming (COBF), coordinated spatial reuse CSR), or coordinated time division multiple access (C-TDMA).

Clause 21: The method any one of Clauses 19-20, where the information is provided via at least one first frame including at least one of a management frame, control frame, or data frame.

Clause 22: The method of Clause 21, where the information is provided via a field of the at least one first frame, the field being associated with a value that indicates the wireless device could benefit from participating the coordinated communication scheme.

Clause 23: The method any one of Clauses 19-22, where the information further indicates a particular type of coordinated communication scheme the wireless device could benefit from.

Clause 24: The method any one of Clauses 19-23, where the information identifies at least one of: the first wireless node; a set of BSS identifiers (BSSIDs) including the first BSS; or a set of BSSIDs including both the first BSS and the second BSS.

Clause 25: The method any one of Clauses 19-24, where the information is provided to at least one of: the first wireless node; a wireless station associated with the wireless device; or a second wireless node associated with a third BSS.

Clause 26: The method any one of Clauses 19-25, where the information further indicates the wireless device has pending buffered data or anticipates upcoming traffic.

Clause 27: The method any one of Clauses 19-26, where the information is provided in a first frame that is an inference request or acknowledges an inference request.

Clause 28: The method any one of Clauses 19-27, where the information is provided via a first communication link; and the information further indicates the wireless device could benefit from participating in the coordinated communication scheme via at least one of the first communication link or a second communication link.

Clause 29: The method any one of Clauses 19-28, where the information further indicates a set of one or more communication links via which the wireless device could benefit from participating in the coordinated communication scheme.

Clause 30: The method any one of Clauses 19-29, where the information is provided via at least one of: one or more random access resource units (RA-RUs); a response to a feedback report poll trigger frame; or resources indicated as pre-emptible by the wireless device in the at least one TXOP or another TXOP associated with the first wireless node.

Clause 31: The method any one of Clauses 19-30, further including: obtaining a first frame from the first wireless node, wherein the information is provided via a response to the first frame.

Clause 32: The method of Clause 31, where the first frame includes a feedback report poll trigger frame.

Clause 33: The method of Clause 31, where the participation in the coordinated communication scheme with the first wireless node, identified via a response to the first frame, is subject to a time constraint.

Clause 34: The method any one of Clauses 19-33, where the information further indicates at least one of: a binary indication the wireless device could benefit from the coordinated communication scheme; a particular type of the coordinated communication scheme the wireless device could benefit from; or timing information indicating when the wireless device could benefit from the coordinated communication scheme.

Clause 35: An apparatus, including: at least one memory including executable instructions; and at least one processor configured to execute the executable instructions and cause the apparatus to perform a method in accordance with any combination of Clauses 1-34.

Clause 36: An apparatus, including means for performing a method in accordance with any combination of Clauses 1-34.

Clause 37: A non-transitory computer-readable medium including executable instructions that, when executed by at least one processor of an apparatus, cause the apparatus to perform a method in accordance with any combination of Clauses 1-34.

Clause 38: A computer program product embodied on a computer-readable storage medium including code for performing a method in accordance with any combination of Clauses 1-34.

Clause 39: A wireless node (e.g., an access point), including: at least one transceiver, at least one memory including instructions; and at least one processor configured to execute the instructions to cause the apparatus to perform a method in accordance with any combination of Clauses 1-18, wherein the at least one transceiver is configured to receive the information.

Clause 40: A wireless node (e.g., an access point), including: at least one transceiver, at least one memory including instructions; and at least one processor configured to execute the instructions to cause the apparatus to perform a method in accordance with any combination of Clauses 19-34, wherein the at least one transceiver is configured to transmit the information.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

Means for outputting, means for participating, and means for obtaining may comprise one or more processors, such as one or more of the processors described above with reference to FIG. 40.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

Means for outputting, means for participating, means for obtaining, and means for providing may comprise one or more processors, such as one or more processors described above (e.g., with reference to FIG. 13).

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising instructions; and
one or more processors configured to execute the instructions to cause the apparatus to:
obtain information indicating a first wireless node is a candidate for participating in a coordinated communication scheme during at least one transmit opportunity (TXOP), wherein the apparatus is associated with a first basic service set (BSS) and the first wireless node is associated with a second BSS; and
participate in the coordinated communication scheme with the first wireless node during the at least one TXOP.

2. The apparatus of claim 1, wherein the coordinated communication scheme involves at least one of: coordinated beamforming (COBF), coordinated spatial reuse CSR), or coordinated time division multiple access (C-TDMA).

3. The apparatus of claim 1, wherein the information is obtained via at least one first frame comprising at least one of a management frame, control frame, or data frame.

4. The apparatus of claim 3, wherein the information is conveyed via a field of the at least one first frame, the field being associated with a value that indicates the first wireless node could benefit from participating the coordinated communication scheme.

5. The apparatus of claim 1, wherein the information further indicates a particular type of coordinated communication scheme the first wireless node could benefit from.

6. The apparatus of claim 1, wherein the information identifies at least one of:
the apparatus;
a set of BSS identifiers (BSSIDs) including the first BSS; or
a set of BSSIDs including both the first BSS and the second BSS.

7. The apparatus of claim 1, wherein the information is obtained from at least one of:
the first wireless node;
a wireless station associated with the first wireless node; or
a second wireless node associated with a third BSS.

8. The apparatus of claim 1, wherein the information further indicates the first wireless node has pending buffered data or anticipates upcoming traffic.

9. The apparatus of claim 1, wherein the information is obtained in a first frame that is an inference request or acknowledges an inference request.

10. The apparatus of claim 1, wherein:
the information is obtained via a first communication link; and
the information further indicates the first wireless node could benefit from participating in the coordinated communication scheme via at least one of the first communication link or a second communication link.

11. The apparatus of claim 1, wherein:
the information further indicates a set of one or more communication links via which the first wireless node could benefit from participating in the coordinated communication scheme.

12. The apparatus of claim 1, wherein the information is obtained via at least one of:
one or more random access resource units (RA-RUs);
a response to a feedback report poll trigger frame; or
resources indicated as preemptible by the first wireless node in the at least one TXOP or another TXOP associated with the apparatus.

13. The apparatus of claim 1, wherein the one or more processors are further configured to execute the instructions to cause the apparatus to:
output a first frame to poll for one or more wireless nodes that could benefit from participating in the coordinated communication scheme.

14. The apparatus of claim 13, wherein:
the information is obtained via a response to the first frame; or
the first frame is output after obtaining the information.

15. The apparatus of claim 13, wherein:
the first frame comprises a feedback report poll trigger frame; and
the information is obtained via a response to the feedback report poll trigger frame.

16. The apparatus of claim 13, wherein the first frame addresses at least one of:
one or more access points (APs); or
one or more non-AP wireless stations.

17. The apparatus of claim 13, wherein the participation in the coordinated communication scheme with the first wireless node, identified via a response to the first frame, is subject to a time constraint.

18. The apparatus of claim 1, wherein the information further indicates at least one of:
a binary indication the first wireless node could benefit from the coordinated communication scheme;
a particular type of the coordinated communication scheme the first wireless node could benefit from; or
timing information indicating when the first wireless node could benefit from the coordinated communication scheme.

19. The apparatus of claim 1, further comprising at least one transceiver configured to receive the information, wherein the apparatus is configured as an access point (AP).

20. An apparatus for wireless communication, comprising:
at least one memory comprising instructions; and
one or more processors configured to execute the instructions to cause the apparatus to:
provide information indicating the apparatus is a candidate for participating in a coordinated communication scheme with a first wireless node during at least one transmit opportunity (TXOP), wherein the first wireless node is associated with a first basic service set (BSS) and the apparatus is associated with a second BSS; and
participate in the coordinated communication scheme with the first wireless node during the at least one TXOP.

21. The apparatus of claim 20, wherein the coordinated communication scheme involves at least one of: coordinated beamforming (COBF), coordinated spatial reuse CSR), or coordinated time division multiple access (C-TDMA).

22. The apparatus of claim 20, wherein the information is provided via at least one first frame comprising at least one of a management frame, control frame, or data frame.

23. The apparatus of claim 22, wherein the information is provided via a field of the at least one first frame, the field being associated with a value that indicates the apparatus could benefit from participating the coordinated communication scheme.

24. The apparatus of claim 20, wherein the information further indicates a particular type of coordinated communication scheme the apparatus could benefit from.

25. The apparatus of claim 20, wherein the information identifies at least one of:
the first wireless node;
a set of BSS identifiers (BSSIDs) including the first BSS; or
a set of BSSIDs including both the first BSS and the second BSS.

26. The apparatus of claim 20, wherein the information is provided to at least one of:
the first wireless node;
a wireless station associated with the apparatus; or
a second wireless node associated with a third BSS.

27. The apparatus of claim 20, wherein the information further indicates the apparatus has pending buffered data or anticipates upcoming traffic.

28. The apparatus of claim 20, wherein the information is provided in a first frame that is an inference request or acknowledges an inference request.

29. The apparatus of claim 20, further comprising at least one transceiver configured to transmit the information, wherein the apparatus is configured as an access point (AP).

30. A method for wireless communication at a wireless node, comprising:
obtaining information indicating a first wireless node is a candidate for participating in a coordinated communication scheme during at least one transmit opportunity (TXOP), wherein the wireless node is associated with a first basic service set (BSS) and the first wireless node is associated with a second BSS; and
participating in the coordinated communication scheme with the first wireless node during the at least one TXOP.
